(19) United States
(12) Patent Application Publication
(10) Pub. No.: US 2023/0188058 A1
(43) Pub. Date: Jun. 15, 2023

(54) PIEZOELECTRIC DRIVE DEVICE AND ROBOT

(71) Applicant: SEIKO EPSON CORPORATION, Tokyo (JP)

(72) Inventor: Yudai OKAMAE, Chino-shi (JP)

(21) Appl. No.: 18/076,425

(22) Filed: Dec. 7, 2022

(30) Foreign Application Priority Data
Dec. 9, 2021 (JP) 2021-199907

(51) Int. Cl. H02N 2/10; B25J 9/12

(52) U.S. Cl. CPC H02N 2/103; B25J 9/12

(57) ABSTRACT

A piezoelectric drive device driving a driven member by a projecting portion provided on one end of a vibrator including a piezoelectric element, includes a fixing portion fixing the piezoelectric drive device, a holding portion holding the vibrator, an urging portion coupled to the fixing portion and urging the holding portion including the vibrator in a direction toward the projecting portion, a weight portion provided at an opposite side to the projecting portion in the holding portion, and an elastic portion placed between the holding portion and the weight portion.

The present application is based on, and claims priority from JP Application Serial Number 2021-199907, filed Dec. 9, 2021, the disclosure of which is hereby incorporated by reference herein in its entirety.

### BACKGROUND

### 1. Technical Field

The present disclosure relates to a piezoelectric drive device and a robot including the piezoelectric drive device.

### 2. Related Art

For example, JP-A-2013-158151 discloses an ultrasonic motor driving a driven member by elliptical vibration generated in a vibrator. According to the document, the ultrasonic motor includes the vibrator in a plate shape having a piezoelectric element stacked on one surface and a pair of projecting portions on the other surface, a holding portion supporting the vibrator, and pressurizing means for pressurizing the holding portion from a back surface, and drives the driven member by elliptical vibration by the pair of projecting portions. That is, the ultrasonic motor of JP-A-2013-158151 drives the driven member located in a perpendicular direction of the vibrator by vibration in a direction of overlap with the plate-like vibrator. In other words, the ultrasonic motor may be a piezoelectric drive device in an out-of-plane vibration mode of vibration outside of a plane containing the vibrator.

Further, a piezoelectric drive device in an in-plane vibration mode of vibration in a direction of a plane containing a vibrator is also known. The piezoelectric drive device includes the vibrator having a projecting portion on one short side of a rectangular shape, a holding portion surrounding the other short side and two long sides of the vibrator and holding the vibrator in a coupling part near the center of the two long sides, a fixing portion supporting the holding portion via a plate spring, etc. In the piezoelectric drive device, a driven member is driven by elliptical vibration along the planar direction of the vibrator generated in the projecting portion of the vibrator.

However, in these piezoelectric drive devices, there is a problem that unnecessary vibration is generated and energy conversion efficiency is poor. In the ultrasonic motor of JP-A-2013-158151, with the vibration of the vibrator, the holding portion holding the vibrator also vibrates. Similarly, in the piezoelectric drive device in the in-plane vibration mode, with the vibration of the vibrator, the holding portion holding the vibrator also vibrates. Due to the unnecessary vibration in the holding portion, there are problems of not only a loss of drive output but also generation of abnormal noise and earlier wear of the projecting portion.

Accordingly, a piezoelectric drive device with reduced unnecessary vibration and excellent energy conversion efficiency is desired.

### SUMMARY

A piezoelectric drive device according to an aspect of the present disclosure is a piezoelectric drive device driving a driven member by a projecting portion provided on one end of a vibrator including a piezoelectric element, including a fixing portion fixing the piezoelectric drive device, a holding portion holding the vibrator, an urging portion coupled to the fixing portion and urging the holding portion including the vibrator in a direction toward the projecting portion, a weight portion provided at an opposite side to the projecting portion in the holding portion, and an elastic portion placed between the holding portion and the weight portion.

A robot according to an aspect of the present disclosure includes the above described piezoelectric drive device, a plurality of arm units, and a drive unit driving the arm units, wherein the piezoelectric drive device is provided in the drive unit.

### BRIEF DESCRIPTION OF THE DRAWINGS

FIG. 1 is a plan view of a piezoelectric motor of a comparative example according to embodiment 1.

FIG. 2 is a perspective view of the piezoelectric motor.

FIG. 3 is a plan view of a piezoelectric actuator.

FIG. 4 is a schematic diagram showing a vibration behavior in a vibrator.

FIG. 5 is a plan view of a piezoelectric motor of embodiment 1.

FIG. 6 is a plan view of a piezoelectric actuator.

FIG. 7 is a graphical representation showing changes in coefficient of friction with or without an elastic portion and a weight portion.

FIG. 8A is a sectional view of a piezoelectric motor of a comparative example according to embodiment 2.

FIG. 8B is a schematic diagram showing a vibration behavior in a vibrator.

FIG. 9 is a sectional view of a piezoelectric motor of embodiment 2.

FIG. 10 is a plan view of a piezoelectric drive device according to embodiment 3.

FIG. 11 is a plan view of a piezoelectric drive device in another form.

FIG. 12 is a schematic diagram of a robot according to embodiment 4.

### DESCRIPTION OF EXEMPLARY EMBODIMENTS

### Embodiment 1

### Outline of Piezoelectric Motor

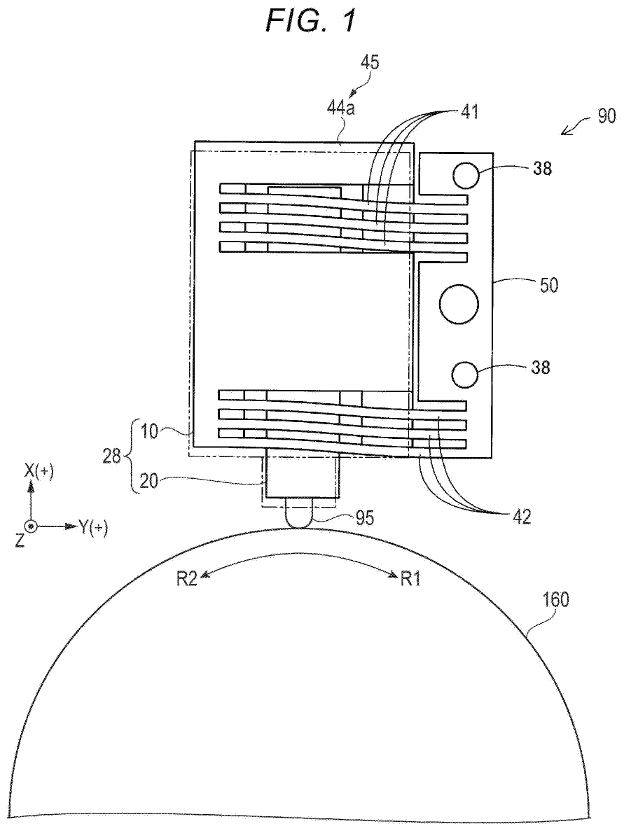

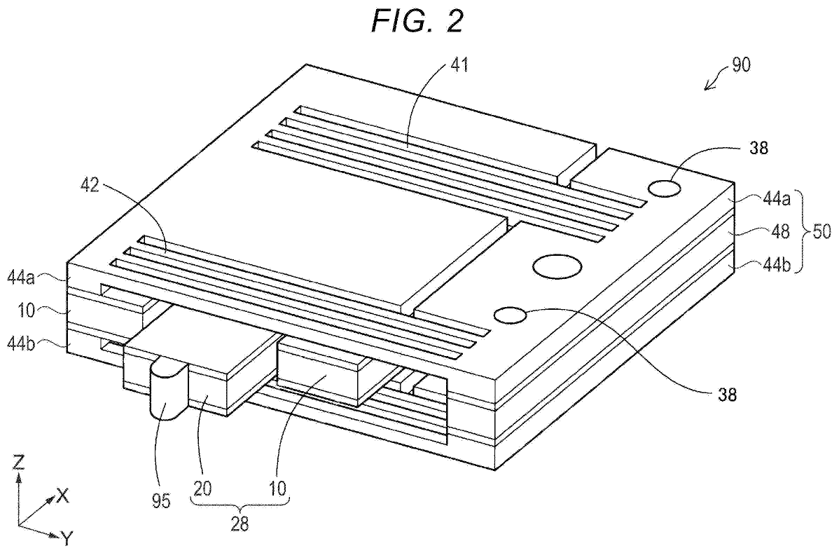

FIG. 1 is a plan view showing an outline of a piezoelectric motor in a comparative example. FIG. 2 is a perspective view of the piezoelectric motor. First, using FIGS. 1 and 2, a schematic configuration of a basic piezoelectric motor 90 will be explained.

FIG. 1 is the plan view of the piezoelectric motor 90 having a basic configuration as the comparative example.

The piezoelectric motor 90 as a piezoelectric drive device is a piezoelectric drive-type motor rotationally moving a rotor 160 in a disc shape as a driven member in a rotation direction R1 or a rotation direction R2 by pressing the rotor by a projecting portion 95 of a vibrator 20. Note that FIG. 1 is an explanatory diagram of the basic configuration and shows a driving behavior by the single piezoelectric motor 90, however, in practice, a multiple-motor configuration for increasing a drive force with a plurality of piezoelectric motors arranged along an outer circumferential edge of the rotor 160 is often employed.

The piezoelectric motor 90 includes a piezoelectric actuator 28, an urging portion 45, a fixing portion 50, etc.

The piezoelectric actuator 28 includes the vibrator 20 having a piezoelectric element as a vibration source, a holding portion 10 holding the vibrator 20, etc. The vibrator 20 has a rectangular shape, and an X-axis is set along the long side direction and a Y-axis is set along the short side direction. Further, a Z-axis is set in the thickness direction of the vibrator 20. The details of the piezoelectric actuator 28 will be described later,

The urging portion 45 includes a pair of parallel springs 44a, 44b placed in the upper part and the lower part of the piezoelectric actuator 28.

As shown in FIG. 1, one end of the parallel spring 44a is integrally formed with the fixing portion 50 and the other end of the parallel spring 44a is coupled to the holding portion 10 of the piezoelectric actuator 28.

In the parallel spring 44a, plate springs 41, 42 extending in the plus direction of the Y-axis are provided and urge the piezoelectric actuator 28 in a direction in which the projecting portion 95 is pressed against the rotor 160. The plate springs 41 are a plurality of plate springs provided at the rear end side of the vibrator 20 and the plate springs 42 are a plurality of plate springs provided at the front end side of the vibrator 20. The parallel spring 44b provided on the back surface of the piezoelectric actuator 28 has the same configuration.

As shown in FIG. 2, the parallel springs 44a, 44b are provided to sandwich the piezoelectric actuator 28 from upside and downside and urge the piezoelectric actuator 28 in the X minus direction. In other words, the urging portion 45 couples the holding portion 10 including the vibrator 20 urged in a direction toward the projecting portion 95 to the fixing portion 50.

The fixing portion 50 includes a base member 48, the parallel springs 44a, 44b, etc. The fixing portion 50 is integrated with the parallel spring 44a and the parallel spring 44b superimposed on the upside and the downside of the base member 48 as a base. The fixing portion is fixed to an attached portion (not shown) by screws through two screw holes 38. Further, an end part at the opposite side to the fixing portion 50 in the piezoelectric actuator 28 is integrated with the parallel spring 44a and the parallel spring 44b superimposed on the upside and the downside of the holding portion 10.

Referring to FIG. 1, the piezoelectric motor 90 having the above described configuration applies a rotational force by flexural motion of the vibrator 20 with the projecting portion 95 pressing the rotor 160 by restoring forces of the plurality of plate springs 41, 42.

An encoder (not shown) is provided in the rotor 160 and the behavior of the rotor 160, particularly, the rotation amount and the angular velocity can be detected by the encoder.

### Outline of Piezoelectric Actuator

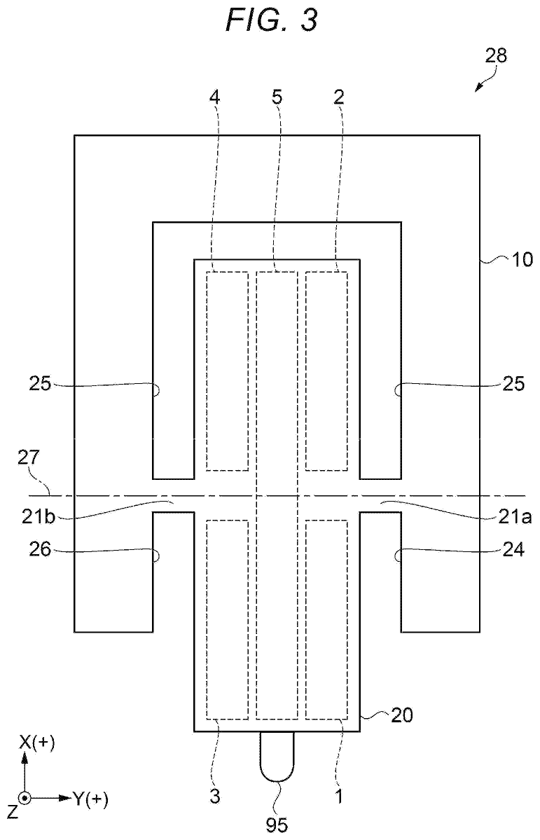

FIG. 3 is a plan view of the piezoelectric actuator.

As shown in FIG. 3, the holding portion 10 has a rectangular shape and uses a silicon substrate as a preferable example. Note that silicon substrates are also used for the urging portion 45 and the fixing portion 50 in a preferable example, however; the materials are not limited to those as long as the materials have equivalent properties. For example, metals may be used.

The vibrator 20 is a part sectioned in a rectangular shape within the holding portion 10 and piezoelectric elements 1 to 5 for driving are placed on the front surface side. Specifically, the vibrator 20 is sectioned substantially in the rectangular shape by three cutout portions 24 to 26 provided in the holding portion 10 having the substantially rectangular shape. The vibrator is coupled to the holding portion 10 by a pair of supporting arms 21a, 21b left substantially at the center of the long sides of the rectangular shape. Further, a line segment passing through the supporting arms 21a, 21b and extending in the Y plus direction is a center line 27.

The rectangular piezoelectric elements 1, 2 are placed along one long side of the vibrator 20. The piezoelectric element 1 and the piezoelectric element 2 are line-symmetrically placed with respect to the center line 27.

Similarly, the rectangular piezoelectric elements 3, 4 are placed along the other long side of the vibrator 20. The piezoelectric element 3 and the piezoelectric element 4 are line-symmetrically placed with respect to the center line 27.

Further, the rectangular piezoelectric element 5 having a length equal to the length of the connected piezoelectric element 1 and piezoelectric element 2 is provided at the center of the vibrator 20.

Though not shown in FIG. 3, electrodes and wires for supplying drive signals to the piezoelectric elements are provided on the upper surfaces of the piezoelectric elements 1 to 5. The electrically same wires are coupled to the piezoelectric element 1 and the piezoelectric element 4 diagonally located in the vibrator 20. Similarly, the electrically same wires are coupled to the piezoelectric element 2 and the piezoelectric element 3. The other wire than the above described wires is coupled to the piezoelectric element 5. A common wire is provided on the lower layer side of the piezoelectric elements 1 to 5. The common wire is coupled to the ground potential in a preferable example.

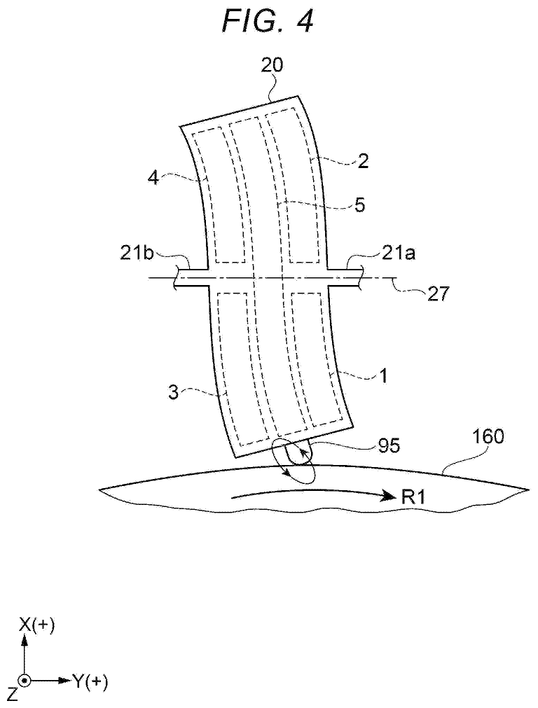

FIG. 4 shows a motion behavior when the vibrator is driven and corresponds to FIG. 3.

First, an alternating-current drive signal supplied to the piezoelectric elements 1, 4 is a first drive signal. To the piezoelectric elements 2, 3, a second drive signal at different phase by 180 degrees from the first drive signal is supplied. To the piezoelectric element 5, a third drive signal at different phase from that of the first drive signal and the second drive signal is supplied. For example, as the third drive signal, a signal at different phase by 90 degrees from the first drive signal is supplied.

The respective drive signals are supplied to the piezoelectric elements 1 to 5, and thereby, as shown in FIG. 4, the vibrator 20 stretchingly vibrates in the long side direction and flexurally vibrates in the short side direction. In other words, the piezoelectric elements 1 to 5 make in-plane vibrations in the plane of the substrate. These vibrations are synthesized, and then, for example, the tip of the projecting portion 95 makes an elliptical motion moving in an elliptical orbit counterclockwise as shown by arrows. The rotor 160 is moved out by the elliptical motion of the projecting portion 95 and the rotor 160 rotates clockwise in a direction shown by the rotation direction R1.

When the piezoelectric motor 90 having the above described basic configuration is driven, there is a problem that, with the vibration of the vibrator 20, the holding portion 10 holding the vibrator 20 also vibrates. Specifically, in FIG. 3, when the vibrator 20 is driven to vibrate within the plane containing the X-axis and the Y-axis, the holding portion 10 also vibrates within the same plane via the supporting arms 21a, 21b. The vibration is unnecessary vibration that does not contribute to the drive force and the drive output is lost. There are associated problems of generation of abnormal noise and earlier wear of the projecting portion 95.

### Configuration of Piezoelectric Motor

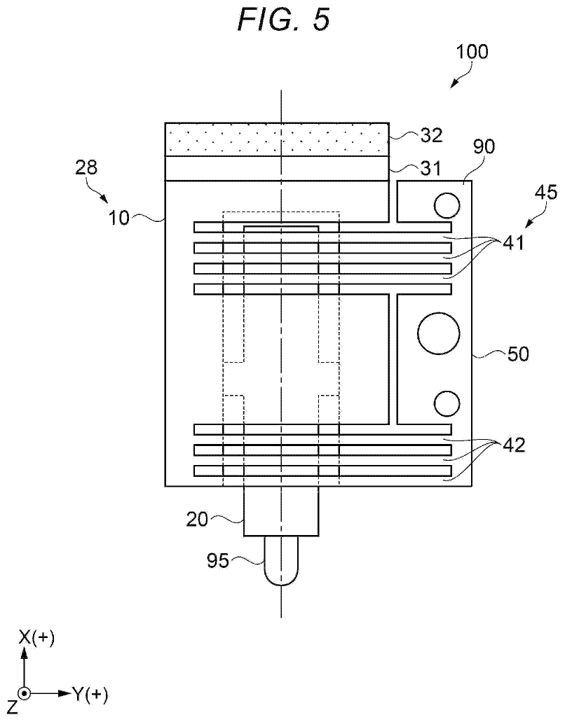

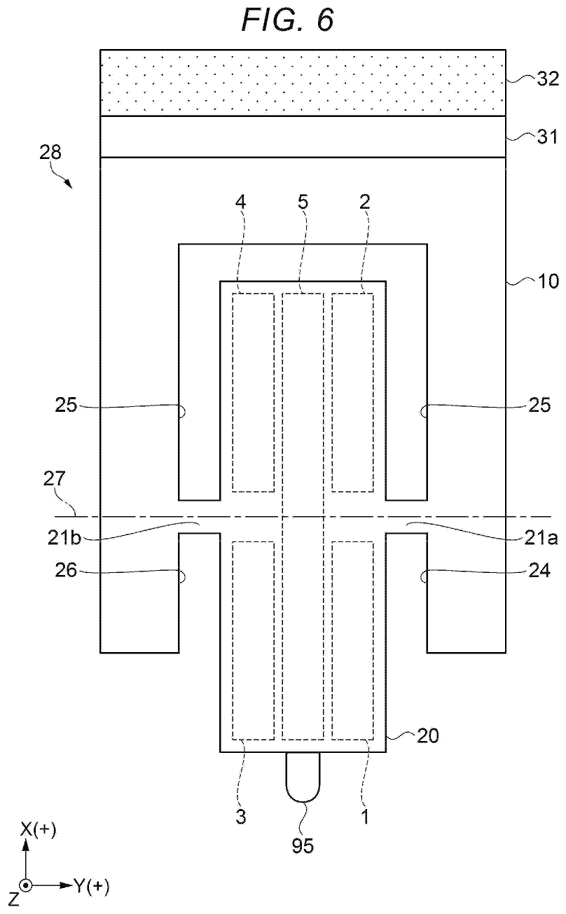

FIG. 5 is a plan view of a piezoelectric motor of embodiment 1 and corresponds to FIG. 1. FIG. 6 is a plan view of a piezoelectric actuator and corresponds to FIG. 3.

FIG. 5 is the plan view of a piezoelectric motor 100 of the embodiment and includes a configuration for reducing the above described unnecessary vibration. Specifically, an elastic portion 31 and a weight portion 32 are provided at the rear end of the piezoelectric actuator 28. Thereby, the urging portion 45 is located between the projecting portion 95 and the weight portion 32 in a plan view. The other configurations than these are the same as those of the above described piezoelectric motor 90.

As shown in FIG. 6, the widths of the elastic portion 31 and the weight portion 32 are substantially the same as the width of the holding portion 10 and the portions are bonded to an end surface at the X plus side of the holding portion 10. Further, the thicknesses of the elastic portion 31 and the weight portion 32 are substantially the same as the thickness of the holding portion 10. In a preferable example, the elastic portion 31 is bonded to the holding portion 10 by an adhesive and the weight portion 32 is bonded to the elastic portion 31 by an adhesive. The method is not limited to that as long as the elastic portion 31 and the weight portion 32 can be bonded to the end part of the holding portion 10. In other words, the weight portion 32 is provided at the opposite side to the projecting portion 95 in the holding portion 10 and the elastic portion 31 is placed between the holding portion 10 and the weight portion 32.

In a preferable example, low resilience urethane rubber is used for the material of the elastic portion 31. The material is not limited to that, but any elastic member e.g. elastomer, rubber, and foamed members thereof may be used.

In a preferable example, brass is used for the material of the weight portion 32. The material is not limited to that, but any material having a larger specific gravity e.g. metals such as gold, tungsten, lead, copper, and iron and alloys thereof may be used.

The materials of the elastic portion 31 and the weight portion 32 may be materials having properties that can function as dynamic vibration absorbers. For example, it is preferable that the Young's modulus of the weight portion 32 is larger than the Young's modulus of the elastic portion 31.

### Reduction Verification Result of Unnecessary Vibration

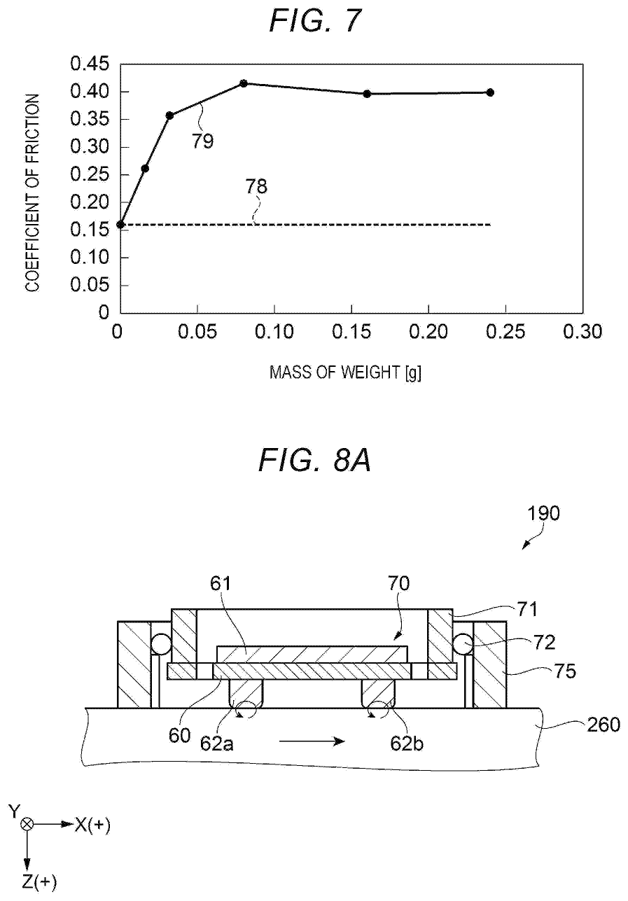

FIG. 7 is a graphical representation showing changes in coefficient of friction with or without the elastic portion and the weight portion. The horizontal axis shows a mass (g) of the weight and the vertical axis takes a coefficient of friction.

First, a verification method for the vibration behavior with or without the elastic portion 31 and the weight portion 32 is explained using FIG. 1.

The verification method is to rotationally slide the rotor 160 for inspection in contact with the piezoelectric motor 90, 100 with pressurization load P and detect the frictional force between the rotor 160 and the projecting portion 95, and then, derive a coefficient of friction from the detected frictional force by calculation. Concurrently, the drive signal is not applied to the piezoelectric motor 90, 100 and the vibrator receives and vibrates with the rotation of the rotor 160.

A graph 79 shown in FIG. 7 shows changes in coefficient of friction in the piezoelectric motor 100 including the elastic portion 31 and the weight portion 32. The mass of the weight in FIG. 7 is a mass as the sum of the mass of the elastic portion 31 and the mass of the weight portion 32. The pressurization load P is set to 4.8 N. The mass of the piezoelectric motor 90 without the weight as a reference for comparison is 0.274 g. As the piezoelectric motor 100 used for the test, a small piezoelectric motor having an outer shape of about 1 cm square is employed.

A graph 78 is a comparative graph and shows a coefficient of friction of the piezoelectric motor 90 having the basic configuration without the elastic portion 31 and the weight portion 32. The graph 78 is constant at the coefficient of friction of 0.16.

On the other hand, in the graph 79, when the mass of the weight is 0.016 g, the coefficient of friction is 0.26, when the mass of the weight is 0.032 g, the coefficient of friction is 0.36, and the coefficient of friction is larger proportionally to the mass. When the mass of the weight is 0.08 g, the coefficient of friction reaches 0.41, and the coefficient of friction remains at the same level even when the mass increases. It is understood that, when the mass of the weight 0.032 g/the mass of the piezoelectric motor 90 0.274 g=11.7% and the ratio of the weight to the mass of the piezoelectric motor is about 12% or more, the coefficient of friction becomes substantially constant at about 0.4. The coefficient of friction 0.4 is 2.5 times the coefficient of friction 0.16 without the weight.

The frictional force is obtained from the expression (1).

Frictional Force=Coefficient of Friction×Pressurization Load P (1)

From the expression (1), when the mass of the weight is 0 g, the frictional force is 0.16×4.8 N=0.768 N. On the other hand, when the mass of the weight is 0.032 g, the frictional force is 0.36×4.8 N=1.728 N.

That is, it is known that, when the ratio of the weight to the mass of the piezoelectric motor is about 12% or more, the frictional force of about 1.7 N or more is generated.

Here, a relationship between the frictional force and the unnecessary vibration is explained.

First, in the piezoelectric motor 90 with the weight mass 0 g, unnecessary vibration is generated as described above, and the projecting portion 95 making the elliptical motion often separates from the rotor 160 by the unnecessary vibration. That is, it is considered that the drive force is lost due to idling of the projecting portion 95 by the unnecessary vibration.

On the other hand, in the piezoelectric motor 100 including the elastic portion 31 and the weight portion 32, when the weight ratio becomes about 12% or more, the frictional force increases, and it is considered that the projecting portion 95 reliably contacts the rotor 160 and the pressure is converted into the drive force. That is, the unnecessary vibration is reduced, and thereby, idling is reduced and the proper drive force may be exerted.

As described above, according to the piezoelectric motor 100 of the embodiment, the following effects may be obtained.

The piezoelectric drive device is the piezoelectric motor 100 driving the driven member by the projecting portion 95 provided on one end of the vibrator 20 and includes the fixing portion 50 fixing the piezoelectric motor 100, the holding portion 10 holding the vibrator 20, the urging portion 45 urging the holding portion 10 including the vibrator 20 in the direction toward the projecting portion 95, the weight portion 32 provided at the opposite side to the projecting portion 95 in the holding portion 10 and the elastic portion 31 placed between the holding portion 10 and the weight portion 32.

According to the configuration, the elastic portion 31 and the weight portion 32 provided on the rear end of the holding portion 10 of the piezoelectric actuator 28 function as dynamic vibration absorbers, and thereby, unnecessary vibration may be reduced. Further, abnormal noise and wear of the projecting portion with the unnecessary vibration may be suppressed.

Therefore, the piezoelectric motor 100 as the piezoelectric drive device with reduced unnecessary vibration and excellent energy conversion efficiency may be provided.

It is preferable that the Young's modulus of the weight portion 32 is larger than the Young's modulus of the elastic portion 31.

According to the configuration, the materials that can function as the dynamic vibration absorbers may be selected for the elastic portion 31 and the weight portion 32.

It is preferable that the weight portion 32 contains a metal.

According to the configuration, the weight portion 32 may be formed using the material having the larger specific gravity, and the weight portion may have a function as a mass body for the dynamic vibration absorber.

It is preferable that the elastic portion 31 is an elastomer.

According to the configuration, the elastic portion 31 may be formed using the elastomer as an elastic body, and thereby, the elastic portion may have a function as a spring for the dynamic vibration absorber.

It is preferable that the vibrator 20 includes the silicon substrate and the piezoelectric elements 1 to 5 make in-plane vibration in the plane of the substrate.

According to the configuration, the in-plane vibration type-piezoelectric motor 100 with less unnecessary vibration and higher efficiency may be provided.

In the plan view, the urging portion 45 is provided between the projecting portion 95 and the weight portion 32.

According to the configuration, the urging portion 45 including the plate springs 41, 42 is superimposed on the vibrator 20, and the small piezoelectric motor 100 may be provided.

### Embodiment 2

### Application to Piezoelectric Motor in Out-of-Plane Vibration Mode

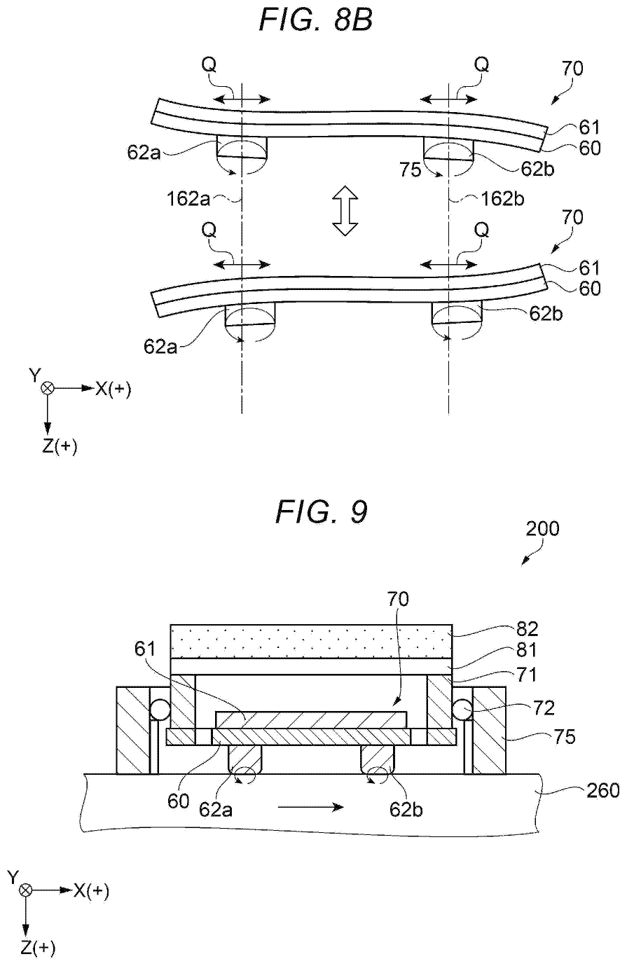

FIG. 8A is a sectional view of a piezoelectric motor in a comparative example. FIG. 8B is a schematic diagram showing a vibration behavior in a vibrating portion.

In the above described embodiment, the example in which the elastic portion 31 and the weight portion 32 are applied to the piezoelectric motor 100 in the in-plane mode is explained, however, the same configuration may be applied to a piezoelectric motor in an out-of-plane vibration mode.

A basic piezoelectric motor 190 in the out-of-plane vibration mode drives a driven member 260 in e.g. the X plus direction by elliptical vibration by two projecting portions 62a, 62b provided in a vibrator 70.

The piezoelectric motor 190 includes the vibrator 70, a holding portion 71, a fixing portion 75, etc.

The vibrator 70 includes a substrate 60, a piezoelectric element 61, the projecting portions 62a, 62b, etc. The substrate 60 is a vibrating plate and has the piezoelectric element 61 stacked on one surface and the projecting portions 62a, 62b provided on the other surface.

The holding portion 71 is a member holding the vibrator 70. The holding portion 71 is supported by the fixing portion 75 via a pair of rollers 72.

The fixing portion 75 supports the holding portion 71 and urges the piezoelectric motor 190 against the driven member 260, and is fixed to a base (not shown) at the Z minus side. In other words, the fixing portion 75 is a base portion holding the vibrator 70 and the holding portion 71 displaceably in the Z direction as the urging direction via the pair of rollers 72.

As shown in FIG. 8B, the vibrator 70 performs flexural vibration to repeat the flexion state in the upper part and the flexion state in the lower part when driven. Specifically, in the longitudinal directions (X-axis directions) of the vibrator 70, the vibrator 70 performs flexural vibration with two vibration nodes 162a, 162b of the vibration node 162a passing through the projecting portion 62a and the vibration node 162b passing through the projecting portion 62b as supporting points. The reciprocating motion shown by arrows Q is also called feed vibration. Further, though not shown in the drawing, in the lateral directions (Y-axis directions) of the vibrator 70, the vibrator performs vibration to move the projecting portions 62a, 62b upward and downward in the Z-axis directions. The reciprocating motion is also called thrust-up vibration.

As shown in FIG. 8A, according to the piezoelectric motor 190, the vibrator 70 performs flexural vibration as a combination of the feed vibration and the thrust-up vibration, and thereby, elliptical vibration is generated in the projecting portions 62a, 62b. The projecting portions 62a, 62b alternately transmit the frictional force to the driven member 260 by the elliptical vibration, and thereby, the driven member 260 is driven.

Also, in the piezoelectric motor 190 in the out-of-plane vibration mode, there is a problem that, with the vibration of the vibrator 70, the holding portion 71 holding the vibrator 70 also vibrates. Specifically, in FIG. 8A, when the vibrator 70 is driven to vibrate in the Z plus/minus directions, the holding portion 71 also vibrates. The vibration is unnecessary vibration that does not contribute to the drive force and the drive output is lost. There are associated problems of generation of abnormal noise and earlier wear of the projecting portions 62a, 62b due to the unnecessary vibration.

### Configuration of Piezoelectric Motor

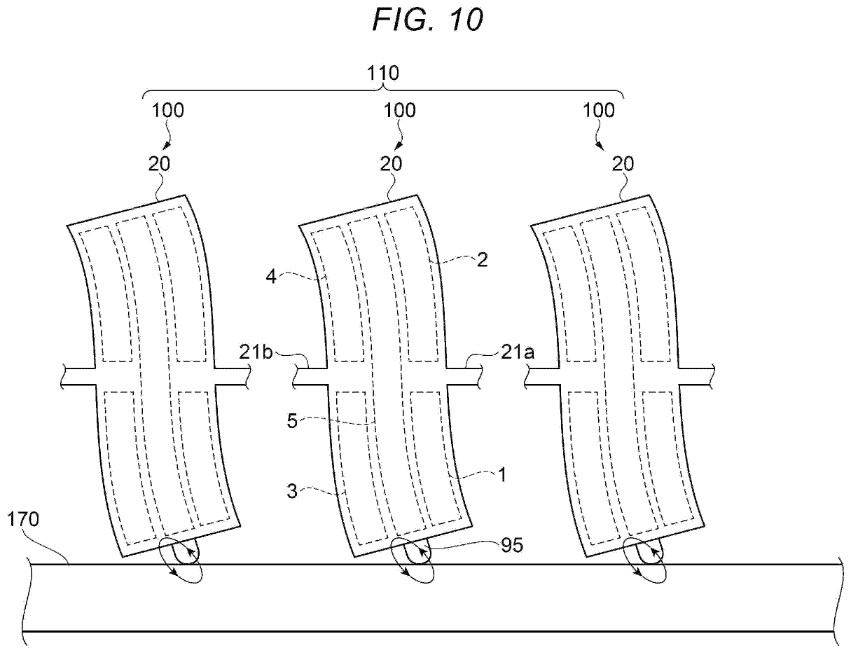

FIG. 9 is a sectional view of a piezoelectric motor of embodiment 2 and corresponds to FIG. 8A.

A piezoelectric motor 200 of the embodiment shown in FIG. 9 includes a configuration for reducing unnecessary vibration. Specifically, an elastic portion 81 and a weight portion 82 are provided in the upper part of the holding portion 71. The other configurations than these are the same as those of the above described piezoelectric motor 190.

As shown in FIG. 9, the elastic portion 81 and the weight portion 82 are superimposed on the holding portion 71 and fixed by adhesives in a preferable example. In other words, the weight portion 82 is provided at the opposite side to the projecting portions 62a, 62b in the holding portion 71 including the vibrator 70, and the elastic portion 81 is placed between the holding portion 71 and the weight portion 82.

Further, the elastic portion 81 is formed using the same material as the elastic portion 31 of embodiment 1. The weight portion 82 is formed using the same material as the weight portion 32 of embodiment 1.

The elastic portion 81 and the weight portion 82 are stacked in the Z minus direction to suppress unnecessary vibration in the Z plus/minus directions of the holding portion 71.

As described above, according to the piezoelectric motor 200 of the embodiment, the following effects may be obtained in addition to the effects in the above described embodiment.

The piezoelectric motor 200 includes the elastic portion 81 and the weight portion 82 functioning as dynamic vibration absorbers on the holding portion 71. Accordingly, the unnecessary vibration in the holding portion 71 generated with driving of the vibrator 70 may be reduced. Further, abnormal noise and wear of the projecting portions with the unnecessary vibration may be suppressed.

Therefore, the piezoelectric motor 200 in the out-of-plane mode as the piezoelectric drive device with reduced unnecessary vibration and excellent energy conversion efficiency may be provided.

### Embodiment 3

### Linear Actuator, Multiple-Motor Drive

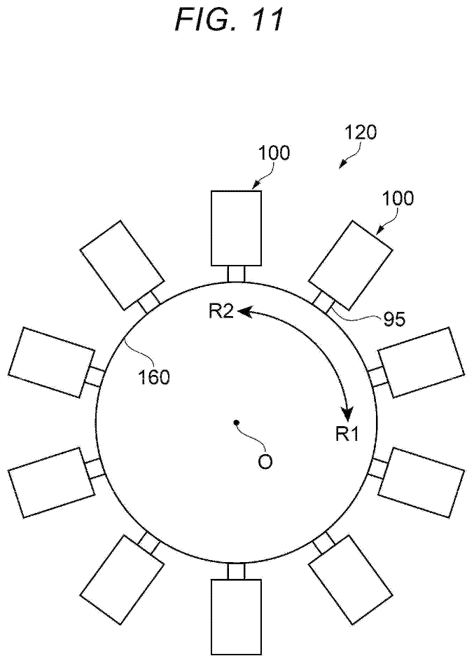

FIGS. 10 and 11 show different forms of the piezoelectric drive device.

In embodiment 1, the form of driving to rotate the disc-shaped rotor 160 (FIG. 1) using the piezoelectric motor 100 is explained, however, the motor may be applied to e.g. a linear actuator.

As shown in FIG. 10, a piezoelectric drive device 110 of the embodiment includes three piezoelectric motors 100 adjacently placed on the side surface of a rod-shaped rod 170. Specifically, the piezoelectric drive device 110 includes the three piezoelectric motors 100 placed at fixed distances on the same side surface of the rod 170. According to the piezoelectric drive device 110, the rod 170 may be moved in the extension direction thereof by a large drive force as a total of frictional forces by the three piezoelectric motors 100. Note that the number of multiple motors is not limited to three, but the number of piezoelectric motors may be adjusted according to necessary torque. Further, the piezoelectric motors 100 are not necessarily placed on the same side surface of the rod 170 or placed at fixed distances.

As shown in FIG. 11, a piezoelectric drive device 120 of the embodiment includes ten piezoelectric motors 100 placed at fixed distances around the rotor 160.

According to the piezoelectric drive device 120, the rotor 160 may be rotated by a large drive force as a total of frictional forces by the ten piezoelectric motors 100. Note that the number of multiple motors is not limited to ten, but the number of piezoelectric motors may be adjusted according to necessary torque. According to these configurations, the same functions and effects as those of the above described embodiments may be obtained. Further, the piezoelectric motors 100 are not necessarily placed at fixed distances.

### Embodiment 4

### Robot

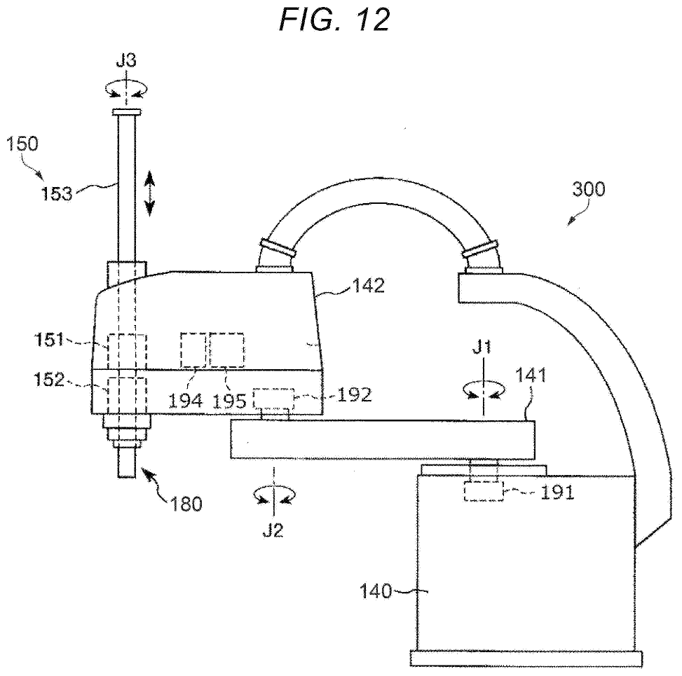

FIG. 12 is a schematic diagram of a robot including arms.

A robot 300 of the embodiment is a horizontal articulated robot (scalar robot) including a plurality of arms.

The robot 300 includes a base 140, a first arm 141, a second arm 142, a working head 150, etc.

The base 140 is a pedestal of the robot 300 and fixed on e.g. a floor surface by bolts or the like. The installation location of the base 140 is not limited to the floor, but may be e.g. a wall, a ceiling, a movable platform, or the like.

The first arm 141 is pivotably coupled to the base 140 via a joint portion.

The second arm 142 is pivotably coupled to the first arm 141 via a joint portion. The working head 150 is provided at the distal end side of the second arm 142.

A drive unit 191 pivoting the first arm 141 around an axis J1 relative to the base 140 is provided inside of the base 140. The drive unit 191 includes a drive motor as a drive source driving the first arm 141. Further, a joint mechanism including a gear and a rotation shaft is incorporated in the joint portion (not shown).

A drive unit 192 pivoting the second arm 142 around an axis J2 relative to the first arm 141 is provided inside of the second arm 142. The configuration of the drive unit 192 and the joint portion thereof is the same as the configuration of the drive unit 191. Note that driving of the drive units 191, 192, 194, 195 is controlled by a robot control unit (not shown) including one or more processors.

The working head 150 is provided in the distal end portion of the second arm 142 and includes a spline nut 151, a ball screw nut 152, a spline shaft 153, etc.

The rod-shaped spline shaft 153 is inserted through the spline nut 151 and the ball screw nut 152 as an axis.

The spline shaft 153 is rotatable around the axis and elevatable in the upward and downward directions. Specifically, rotation and elevation driving is performed by the drive unit 194 and the drive unit 195 provided inside of the second arm 142. When the spline nut 151 is rotationally driven by the drive unit 194, the spline shaft 153 rotates around an axis J3 with the rotation. When the ball screw nut 152 is rotationally driven by the drive unit 195, the spline shaft 153 moves upward and downward with the rotation.

Further, a hand 180 as an end effector is attached to the distal end portion (lower end portion) of the spline shaft 153.

Here, the piezoelectric drive device 120 using the multiple piezoelectric motors 100 of the above described embodiment as drive sources is employed for the drive unit 191 of the first arm 141. Similarly, the piezoelectric drive devices 120 are used as drive motors for the drive units 192, 194, 195. Note that a piezoelectric drive device using the multiple piezoelectric motors 200 may be employed. In other words, the robot 300 includes the first arm 141 and the second arm 142 as a plurality of arm units and the drive units 191, 192 driving the plurality of arm units and the piezoelectric drive devices 120 are provided in the drive units 191, 192.

According to the configuration, the piezoelectric drive devices 120 with reduced unnecessary vibration and excellent energy conversion efficiency are used as the drive sources, and thereby, the robot 300 that can perform highly efficient work with low power consumption may be provided.

When the hand 180 includes fingers for work, the piezoelectric motors 100, 200 or the piezoelectric drive devices 110, 120 of the above described embodiments may be used as the drive sources for the fingers.

Here, the explanation is made using the horizontal articulated robot, however, any robot having an arm e.g. a vertical articulated robot including a six-axis vertical articulated robot may be employed. According to these configurations, the same effects as the functions and the effects in the above described respective embodiments may be obtained.

What is claimed is:

1. A piezoelectric drive device driving a driven member by a projecting portion provided on one end of a vibrator including a piezoelectric element, comprising:
a fixing portion fixing the piezoelectric drive device;
a holding portion holding the vibrator;
an urging portion coupled to the fixing portion and urging the holding portion including the vibrator in a direction toward the projecting portion;
a weight portion provided at an opposite side to the projecting portion in the holding portion; and
an elastic portion placed between the holding portion and the weight portion.

2. The piezoelectric drive device according to claim 1, wherein
a Young's modulus of the weight portion is larger than a Young's modulus of the elastic portion.

3. The piezoelectric drive device according to claim 1, wherein
the weight portion contains a metal.

4. The piezoelectric drive device according to claim 1, wherein
the elastic portion is an elastomer.

5. The piezoelectric drive device according to claim 1, wherein
the vibrator includes a substrate, and
the piezoelectric element performs in-plane vibration in a plane of the substrate.

6. The piezoelectric drive device according to claim 5, wherein
the urging portion is provided between the projecting portion and the weight portion in a plan view from a normal direction of the plane of the substrate.

7. A robot comprising:
the piezoelectric drive device according to claim 1;
an arm unit; and
a drive unit driving the arm unit, wherein
the piezoelectric drive device is provided in the drive unit.
